(19) United States
(12) Patent Application Publication
(10) Pub. No.: US 2018/0241905 A1
(43) Pub. Date: Aug. 23, 2018

(54) IMAGE PROCESSING APPARATUS AND NON-TRANSITORY COMPUTER READABLE MEDIUM

(71) Applicant: FUJI XEROX CO., LTD., Tokyo (JP)

(72) Inventors: Kazutoshi YATSUDA, Kanagawa (JP); Takaaki KASHIWAGI, Kanagawa (JP); Masayasu TAKANO, Kanagawa (JP)

(73) Assignee: FUJI XEROX CO., LTD., Tokyo (JP)

(21) Appl. No.: 15/704,396

(22) Filed: Sep. 14, 2017

(30) Foreign Application Priority Data
Feb. 21, 2017 (JP) 2017-029557

(51) Int. Cl. H04N 1/32; H04N 1/00

(52) U.S. Cl. CPC H04N 1/32122; H04N 1/00511; H04N 1/00514; H04N 2201/3263; H04N 2201/3202; H04N 2201/3215; H04N 2201/3242; H04N 2201/0094

(57) ABSTRACT

An information processing apparatus includes an extracting unit that extracts a number of jobs and job time on a device, and a display that displays on a single graph the number of jobs and total job time in accordance with item, with each item determined to indicate an identical job.

### CROSS-REFERENCE TO RELATED APPLICATIONS

This application is based on and claims priority under 35 USC 119 from Japanese Patent Application No. 2017-029557 filed Feb. 21, 2017.

### BACKGROUND

### (i) Technical Field

The present invention relates to an image processing apparatus and a non-transitory computer readable medium.

### (ii) Related Art

A job or a periodic inspection may be performed on devices in response to a repair request. If total job time is too long even with the job count of the same job being smaller, there is room for improvement. Conversely, if the total job time is too long on the same job with the job count being larger, it is difficult to take a positive step for improvement. Although the job count and the total job time are related to each other in this way, a target for improvement is difficult to find if one factor alone is simply identified.

### SUMMARY

According to an aspect of the invention, there is provided an information processing apparatus. The information processing apparatus includes an extracting unit that extracts a number of jobs and job time on a device, and a display that displays on a single graph the number of jobs and total job time in accordance with item, with each item determined to indicate an identical job.

### BRIEF DESCRIPTION OF THE DRAWINGS

Exemplary embodiment of the present invention will be described in detail based on the following figures, wherein:

FIG. 1 illustrates a conceptual modular configuration of an exemplary embodiment;

FIG. 2 illustrates a configuration of a system of the exemplary embodiment;

FIG. 3 is a flowchart illustrating an example of a process of the exemplary embodiment;

FIG. 4 illustrates a data structure of a repair information table;

FIG. 5 illustrates a display example of a screen in accordance with the exemplary embodiment;

FIG. 6 is a flowchart illustrating an example of a process of the exemplary embodiment;

FIG. 7 illustrates a data structure of a company master table;

FIG. 8 illustrates a data structure of an error code master table;

FIG. 9 illustrates a display example of a screen of the exemplary embodiment;

FIG. 10 is a flowchart illustrating an example of a process of the exemplary embodiment;

FIG. 11 is a flowchart illustrating an example of a process of the exemplary embodiment;

FIG. 12 is a flowchart illustrating an example of a process of the exemplary embodiment;

FIG. 13 illustrates a display example of a screen of the exemplary embodiment;

FIG. 14 illustrates a display example of a screen of the exemplary embodiment;

FIG. 15 illustrates a display example of a screen of the exemplary embodiment; and

FIG. 16 is a block diagram illustrating a hardware configuration of a computer that implements the exemplary embodiment.

### DETAILED DESCRIPTION

An exemplary embodiment of the present invention is described below with reference to the drawings.

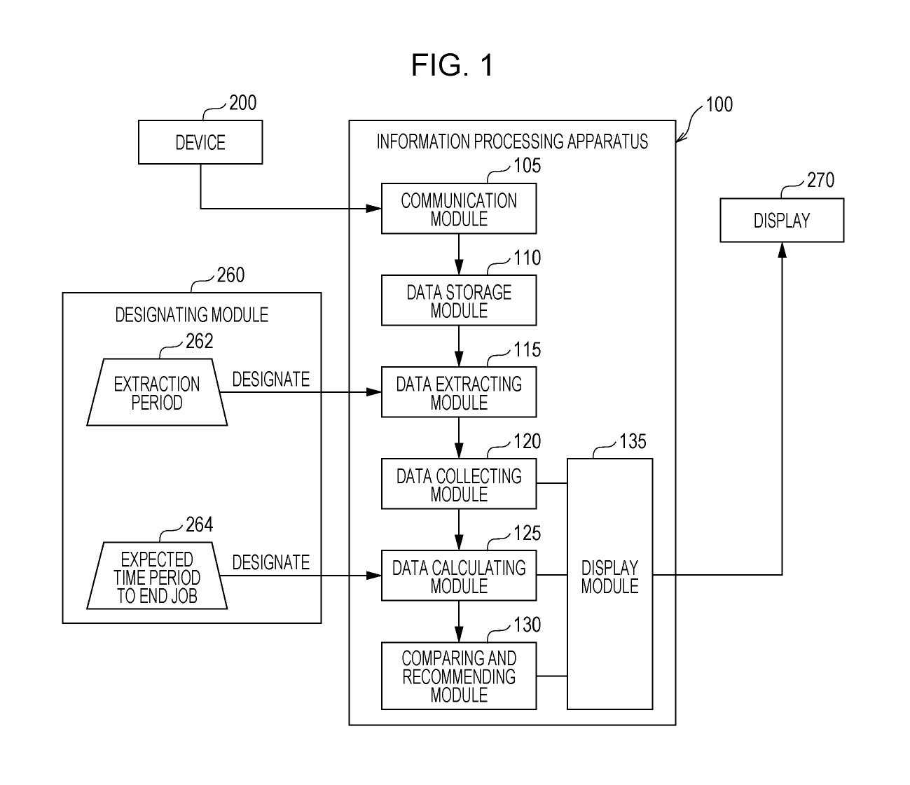

FIG. 1 illustrates a conceptual modular configuration of an exemplary embodiment.

The term module refers to a software component that is logically separable (a computer program), or a hardware component. The module of the exemplary embodiment refers to not only a module in a computer program but also a module in a hardware configuration. The discussion of the exemplary embodiment also serves as the discussion of computer programs for causing the modules to function (including a program that causes a computer to execute each step, a program that causes the computer to function as an element, and a program that causes the computer to implement each function), a system and a method. In the discussion that follows, the phrases “stores information,” “causes information to be stored,” and other phrases equivalent thereto are used. If the exemplary embodiment is a computer program, these phrases are intended to express “causes a memory device to store information” or “controls a memory device to cause the memory device to store information.” The modules may correspond to the functions in a one-to-one correspondence. In software implementation, one module may be composed of one program or multiple modules may be composed of one program. One module may be composed of multiple programs. Multiple modules may be executed by a single computer. A single module may be executed by multiple computers in a distributed environment or a parallel environment. One module may include another module. In the discussion that follows, the term “connection” refers to not only a physical connection but also a logical connection (such as an exchange of data, instructions, and data reference relationship). The term “predetermined” means that something is decided in advance of a process of interest. The term “predetermined” is thus intended to refer to something that is decided in advance of a process of interest in the exemplary embodiment. Even after a process in the exemplary embodiment has started, the term “predetermined” refers to something that is decided in advance of a process of interest depending on a condition or a status of the exemplary embodiment at the present point of time or depending on a condition or status of the exemplary embodiment heretofore continuing down to the present point of time. If “predetermined values” are plural, the predetermined values may be different from each other, or two or more of the predetermined values (including all the values) may be equal to each other. A statement that “if A, B is to be performed” is intended to mean that it is determined whether something is A, and that if something is determined as A, an action B is to be taken. The statement becomes meaningless if the determination as to whether something is A is not performed.

The term “system” and the term “apparatus” refer to an arrangement where multiple computers, a hardware configuration, and an apparatus are interconnected via a communication network (including a one-to-one communication connection). The term “system” and the term “apparatus” also refer to an arrangement that includes a single computer, a hardware configuration, and an apparatus. The term “system” and the term “apparatus” have the same definition and are interchangeable with each other. The system in the context of the exemplary embodiment does not include a social system that is a social arrangement formulated by humans.

At each process performed by a module, or at one of the processes performed by a module, information as a process target is read from a memory device, the information is then processed, and the process results are written onto the memory device. A description related to the reading of the information from the memory device prior to the process and the writing of the processed information onto the memory device subsequent to the process may be omitted as appropriate. The memory devices may include a hard disk, a RAM (random-access memory), an external storage medium, a memory device connected via a communication network, and a register within a CPU (central processing unit).

As illustrated in FIG. 1, an information processing apparatus 100 of the exemplary embodiment includes a communication module 105, a data storage module 110, a data extracting module 115, a data collecting module 120, a data calculating module 125, a comparing and recommending module 130, and a display module 135. The information processing apparatus 100 has a functionality of an efficient maintenance support device for a device 200. The device 200 is connected to the communication module 105 in the information processing apparatus 100.

The device 200 may include another facility. The device 200 may be an office machine, such as a copying machine, a facsimile machine, a scanner, a printer, or a multi-function device (an image processing apparatus having at least two functionalities of the scanner, the printer, the copying machine, and the facsimile machine). The device 200 may also be an information appliance, a robot, an automatic ticket gate and a ticket vending machine in a railroad system, an automatic teller machine in a bank, or an elevator or an escalator in a building.

The device 200 is to be repaired in the case of a failure, or is to be periodically maintained. Costs involved in these service jobs may be very high. Plural organizations or persons may be involved. Content of service jobs may be different by organization or person, and the number of jobs and job time may also be different. To cut down on costs involved, a target for improvement is to be identified. The organizations may include a repair company, an inspection company, and a repair section in a company. In the following discussion, a repair company (company A, company B, . . . ) may be quoted as the organization.

The information processing apparatus 100 allows a user to easily find a target for improvement using a graph display.

The communication module 105 is connected to the data storage module 110 and the device 200, and communicates with the device 200. The communication module 105 receives data indicating a usage status of the device 200 (log data, for example), and data regarding repair and inspection, such as time and date content of the repair. More specifically, the data regarding repair and inspection may include data regarding the number of jobs and job time on the device 200. If the data regarding repair and inspection of the device 200 is stored and managed on a device other than the device 200, the communication module 105 is connected to the device that stores and manages the data regarding repair and inspection, and then receives the data regarding repair and inspection. The communication module 105 also transmits from the information processing apparatus 100 to the device 200 instructions (including a transmission instruction of the log data, and a parameter setting instruction and a control instruction of the device 200).

The data storage module 110 is connected to the communication module 105 and the data extracting module 115. The data storage module 110 stores the data received by the communication module 105, and sends the data stored thereon to the data extracting module 115. For example, the data storage module 110 stores as repair information 350 the data regarding the number of jobs and job time on the device 200. In addition, the data storage module 110 stores a company master table 660, an error code master table 670, and the like.

The data extracting module 115 is connected to the data storage module 110, the data collecting module 120, and the designating module 260. The data extracting module 115 extracts the number of jobs and job time on the device 200. Typically, plural devices 200 are included in the system, but a single device 200 may be used. For example, plural companies perform jobs on the single device 200, and job results of the plural companies may be compared.

The data extracting module 115 may extract the number of repairs and job time on the device 200 in accordance with an extraction period 262 that is designated by the designating module 260. The extraction period 262 is a period of time of interest (defined by initial time and date and final time and date) specified by a user's operation.

The data collecting module 120 is connected to the data extracting module 115, the data calculating module 125, and the display module 135. The data collecting module 120 generates data that is used to create a graph (such as a first phase graph).

More specifically, if an item is a failure factor (error code), the data collecting module 120 performs the following operations.

A1 Calculating the total number of repair dispatches by error code

A2 Calculating the total job time of the repair dispatches by error code

A3 Calculating the total number of repair dispatches by error code or by organization (or by person in charge)

A4 Calculating the total job time of the repair dispatches by error code or by organization (or by person in charge)

A5 Calculating the average job time of the repair dispatches by error code or by organization (or person in charge) by dividing the total job time of the repair dispatches (A4) by the total number repair dispatches (A3)

Specifically, if the item is an inspection item, the data collecting module 120 performs the following operations.

B1 Calculating the total number of performed inspections by type of inspection

B2 Calculating the total job time for inspection by type of inspection

B3 Calculating the total number of inspection jobs by type of inspection or by organization (or by person in charge)

B4 Calculating the total inspection job time by type of inspection or by organization (or by person in charge)

B5 Calculating the average time of the inspection jobs by type of inspection or by organization (or by person in charge) by dividing the total inspection job time (B4) by the total number of inspection jobs (B3)

The data calculating module 125 is connected to the data collecting module 120, the comparing and recommending module 130, the display module 135, and the designating module 260. The data calculating module 125 receives expected time period to end job 264 designated by the designating module 260. In response to the expected time period to end job 264, the data calculating module 125 generate data that is used to create a graph (a second phase graph).

More specifically, if the item is a failure factor (error code), the data calculating module 125 performs the following operations.

A6 Substituting for the expected time period to end job 264 the job time in the data exceeding beyond the expected time period to end job 264 designated in the job time of the repair dispatches by error code or by organization (or by person in charge), and calculating the total job time of repair dispatches

A7 Calculating, if the job time is reduced to the expected time period to end job 264, the expected average job time of the repair dispatches by dividing the total job time (A6) by the total number of repair dispatches (A3)

A8 Setting, to be expected reduction time, the job time exceeding beyond the expected time period to end job 264 in the data exceeding beyond the expected time period to end job 264 designated in the job time of repair dispatches by error code or by organization (or by person in charge), and calculating the expected reduction time by error code or by organization (or by person in charge)

A9 Summing the expected reduction time (A8) by error code or by organization (or by person in charge)

More specifically, if the item is an inspection item, the data calculating module 125 performs the following operations.

B6 Substituting for the expected time period to end job 264 the job time in the data exceeding beyond the expected time period to end job 264 designated in the job time for inspection by type of inspection or by organization (or by person in charge)expected time period to end job 264, and calculating the total inspection job time.

B7 Calculating the expected average time of inspection jobs by dividing the total inspection job time (B6) by the total number of inspection jobs (B3) if the job time is reduced to the expected time period to end job 264

B8 Setting, to be expected reduction time, the time exceeding beyond the expected time period to end job 264 in the data exceeding beyond the expected time period to end job 264 designated in the inspection job time by type of inspection or by organization (or by person in charge), and calculating the expected reduction time by type of inspection or by organization (or by person in charge)

B9 Summing the expected reduction time (B8) by type of inspection or by organization (or by person in charge)

The comparing and recommending module 130 is connected to the data calculating module 125 and the display module 135. The comparing and recommending module 130 generates data that is used to create a graph (a third phase graph, for example).

More specifically, if the item is a failure factor (error code), the comparing and recommending module 130 performs the following operation.

A10 Listing up the total expected reduction time by error code in the order of size from a larger value to a smaller value, and displaying an error code as a target for improvement as a recommendation

More specifically, if the item is an inspection item, the comparing and recommending module 130 performs the following operation.

B10 Listing up the total expected reduction time by type of inspection in the order of size from a larger value to a smaller value, and displaying a type of inspection as a target for improvement as a recommendation.

The data calculating module 125 is connected to the data collecting module 120, the data calculating module 125, the comparing and recommending module 130, and the display 270. The display module 135 creates graphs (more specifically, the first phase to the third phase graphs and the recommendations) using the process results of the data collecting module 120, the data calculating module 125, and the comparing and recommending module 130, and displays the graph on the display 270.

The display module 135 displays the number of jobs the total job time extracted by the data extracting module 115 on a single graph item by item, each item indicating an identical job. The display module 135 displays the three-phased graphs, and displays the first phase graph herein. The first phase graph indicates a plot and has a horizontal axis representing error code (as an example of an item that is assumed to represent an identical job), a first vertical axis representing the number of jobs (in the form of a bar graph), and a second vertical axis representing the job time (in the form of an area chart). Since the graph form indicating the number of jobs and the graph form indicating the total job time are represented on the same graph, the two graph forms are desirably different.

The “item that is assumed to represent the identical job” is simply intended to mean an item under which the same type of job is assumed to be performed, and is not intended to mean that the actually identical job is to be performed. The “item” may be a failure factor (hereinafter referred to as an error code) or an inspection item. Given the same error code, repair jobs may be identical. More specifically, in repair jobs with content thereof written on a manual, the same job is expected to be performed. In practice, however, the same job is not necessarily performed, and the content of the repair job may be flexibly modified depending on the job situation. The “item that is assumed to represent the identical job” may be determined, not based on the job actually performed but based on the expectation that the identical job is assumed to be performed. This includes not only the case in which the identical job has been performed, but also the case in which the identical job is assumed to be performed but a different job has been actually performed. A maintenance job in the inspection item is typically performed in accordance with a manual, and an identical job is mostly performed. The expectation that the identical job is expected to be performed is considered to be the “item that is assumed to represent the identical job”.

If an item displayed on the first phase graph is selected by an operator, the display module 135 may display a statistical value of job time of the item and total job time on a single graph according to an organization or a person that has performed the job. The second phase graph is also displayed herein. The statistical values may include an average value, a most frequent value, a medium value, a minimum value, a maximum value of the job time. The total job time may be excluded from the statistical values. The second phase graph may have a horizontal axis representing repair companies (as an example of an organization having performed a job), a first vertical axis representing the job time (in the form of a bar graph), and a second vertical axis representing the total job time (in the form of an area chart). Since the graph form indicating the job time and the graph form indicating the total job time are represented on the same graph, the two graph forms are desirably different.

In the second phase graph, the display module 135 may divide the graph into a job time portion having a statistical value serving as a target and a reduction portion, and displays the divided graph. The display module 135 thus displays the divided graph together with a graph representing a total job time serving as a target. The “job time serving as the target” may be set by an operator. The “job time serving as the target” may be a predetermined value, a statistical value of the job time (an average value thereof, for example), or job time of at an X-th ranking if the job time is sorted according to an organization or a person having performed the job. If the X-th ranking is the first ranking, the job that the organization or person in service has finished within the shortest period of time is used to simulate a job that may be performed by another organization or person.

If an item displayed on the second phase graph is selected by an operator, the display module 135 may display the job time of the item according time and date on which the job has been performed. The third phase graph may illustrate a plot of each job with the horizontal axis representing the repair time and date (an example of the time and date on which the job has been performed), and the vertical axis representing the job time.

In the third phase graph, the display module 135 may display a job not within the job time serving as a target in a different form from a job within the job time.

The display module 135 calculates the total reduction time (corresponding to the expected reduction time, for example) with the job time serving as the target according to the failure factor (for example, according to the error code), and displays the sums of time in the order of size from a larger value to a smaller value. In other words, the display module 135 recommends the failure factor serving as a target for improvement, starting with a longer total time. Such a failure factor has a higher improvement effect.

The designating module 260 instructs the information processing apparatus 100 to display a graph, and the display 270 displays the graph as process results of the information processing apparatus 100. The designating module 260 and the display 270 are included in a user terminal 250 that is operated by a user.

The designating module 260 receives the user's operation, and transmits the extraction period 262 and the expected time period to end job 264 to the information processing apparatus 100. More specifically, the designating module 260 designates the extraction period 262 to the data extracting module 115 in the information processing apparatus 100 and designates the expected time period to end job 264 to the data calculating module 125 in the information processing apparatus 100.

In order to receive the user's operation (the user's look, gesture, voice, or the like), the designating module 260 includes a mouse, a keyboard, a liquid-crystal display with a touchpanel, a camera, a microphone, and the like.

If the item is a failure factor (error code) as the expected time period to end job 264, the designating module 260 performs the following operations.

The expected time period to end job 264 may be designated by a user's operation.

The error code classified on the display screen in operations A1 and A2 is selected by a user's operation.

Time at which the job is expected to end is designated by the user's operation on the screen related to the operations A4 and A5 on the selected error code.

The expected time period to end job 264 may be selected in an automatic fashion.

For example, the maximum value and the minimum value of the average job time calculated in the operation A5 are represented by percentage, and the time at which the job is expected to end may be calculated and designated at a pre-designated percentage. For example, a reduction rate is 0% for the maximum value of the job time, and a reduction rate is 100% for the minimum value of the job time.

If the item is an inspection item as the expected time period to end job 264, the designating module 260 performs the following operations.

The expected time period to end job 264 may be designated by a user's operation.

A type of inspection categorized on the display screen related to operations B1 and B2 is selected by a user's operation. Time at which the job is expected to end is designated by a user's operation on the display screen related to operations B4 and B5 on the selected type of inspection.

The expected time period to end job 264 may be selected in an automatic fashion.

For example, the maximum value and the minimum value of the average job time calculated in the operation B5 are represented by percentage, and the time at which the job is expected to end may be calculated and designated at a pre-designated percentage. For example, a reduction rate is 0% for the maximum value of the job time, and a reduction rate is 100% for the minimum value of the job time.

The display 270 is connected to the display module 135 in the information processing apparatus 100. Under the output control of the display module 135, the display 270 displays to the user the graphs (the first phase graph, the second phase graph, and the third phase graph). The display 270 may include, as hardware, an image output device that provides three-dimensional (3D) images, in addition to a display, such as a liquid-crystal display. The display 270 may also include a printer, an audio output device, such as a speaker, outputting an audio, and a vibration device in combination. The display 270 may use a web browser as software.

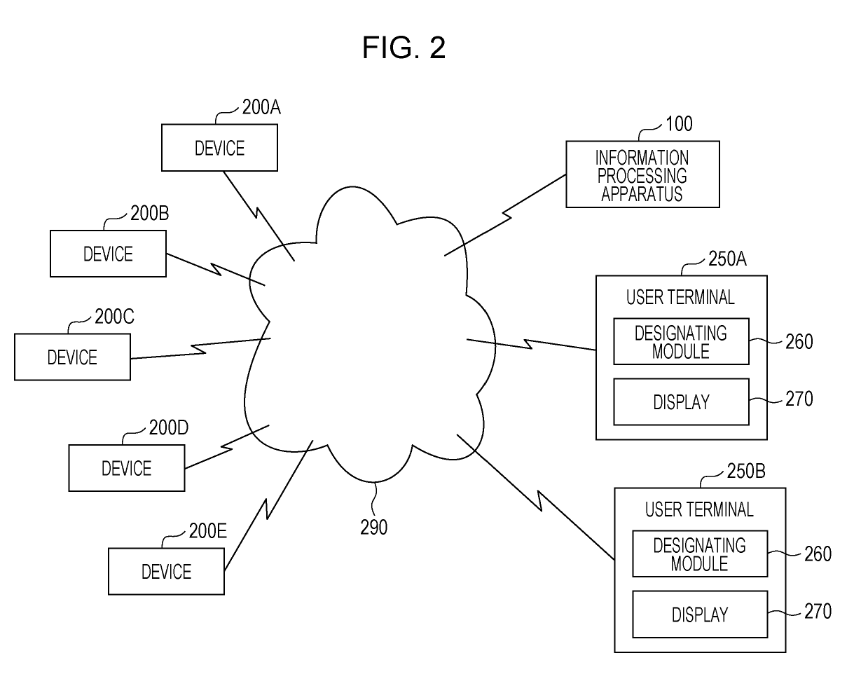

FIG. 2 illustrates a configuration of a system of the exemplary embodiment. The system includes an information processing apparatus 100, a device 200A, a device 200B, a device 200C, a device 200D, a device 200E, a user terminal 250A, a user terminal 250B, and a communication network 290 that interconnects these elements. The communication network 290 may be a wired network, or a radio network, or a combination thereof. The communication network 290 may be the Internet or an intranet as a communication infrastructure. The functionality of the information processing apparatus 100 may be implemented as a cloud service. The user terminal 250 includes the designating module 260, and the display 270. In response to a designate (such as the extraction period 262 or the expected time period to end job 264) provided by the designating module 260 in the user terminal 250, the information processing apparatus 100 creates a graph using data acquired from the device 200, and causes the display 270 in the user terminal 250 to display the graph. In the example of FIG. 2, plural devices 200 are included. As previously described, it is sufficient if at least one device 200 is employed. The user terminal 250 may include the information processing apparatus 100.

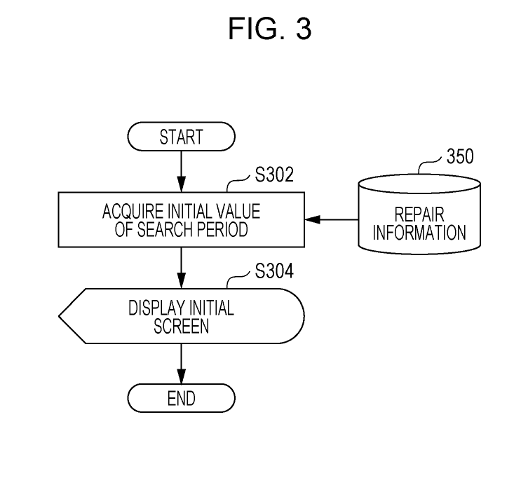

FIG. 3 is a flowchart illustrating an example of a process of the exemplary embodiment.

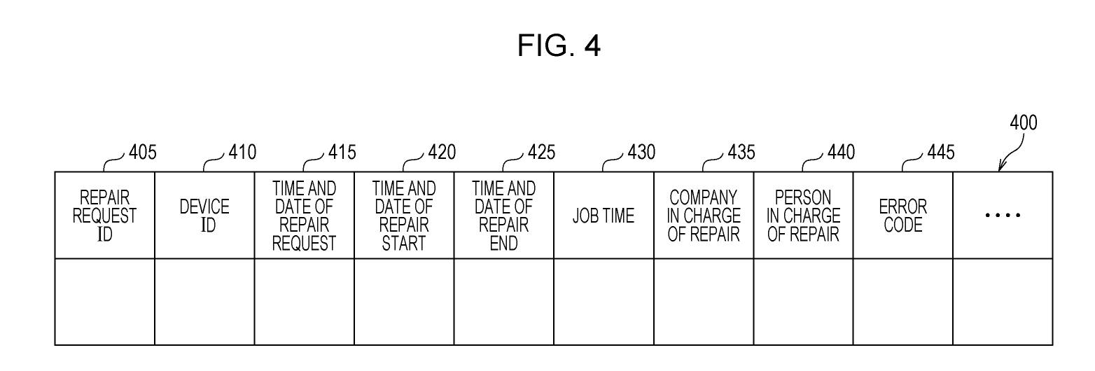

In step S302, an initial value of a search period is acquired as the extraction period 262. The initial value may be a predetermined search period or a predetermined period from the latest repair time and date in the repair information 350 (one month, for example). A repair information table 400 of FIG. 4 is available as the repair information 350. FIG. 4 illustrates a data table structure of the repair information table 400. The repair information table 400 includes a repair request ID column 405, a device ID column 410, a time and date of repair request column 415, a time and date of repair start column 420, a time and date of repair end column 425, a job time column 430, a company in charge of repair column 435, a person in charge repair column 440, and an error code column 445. The repair request ID column 405 stores information uniquely identifying a repair request (repair request identification (ID)). The device ID column 410 stores information uniquely identifying a device (device ID). The time and date of repair request column 415 stores time and date of a repair request (the time and date may indicate the year, the month, the day, the hour, the minute, the second, and a time segment less than a second, or a combination thereof). The time and date of repair start column 420 stores the time and date of a repair start. The time and date of repair end column 425 stores the time and date of a repair end. The job time column 430 stores job time. The company in charge of repair column 435 stores information regarding a company in charge of the repair. The person in charge repair column 440 stores information regarding a person in charge of the repair. The error code column 445 stores an error code.

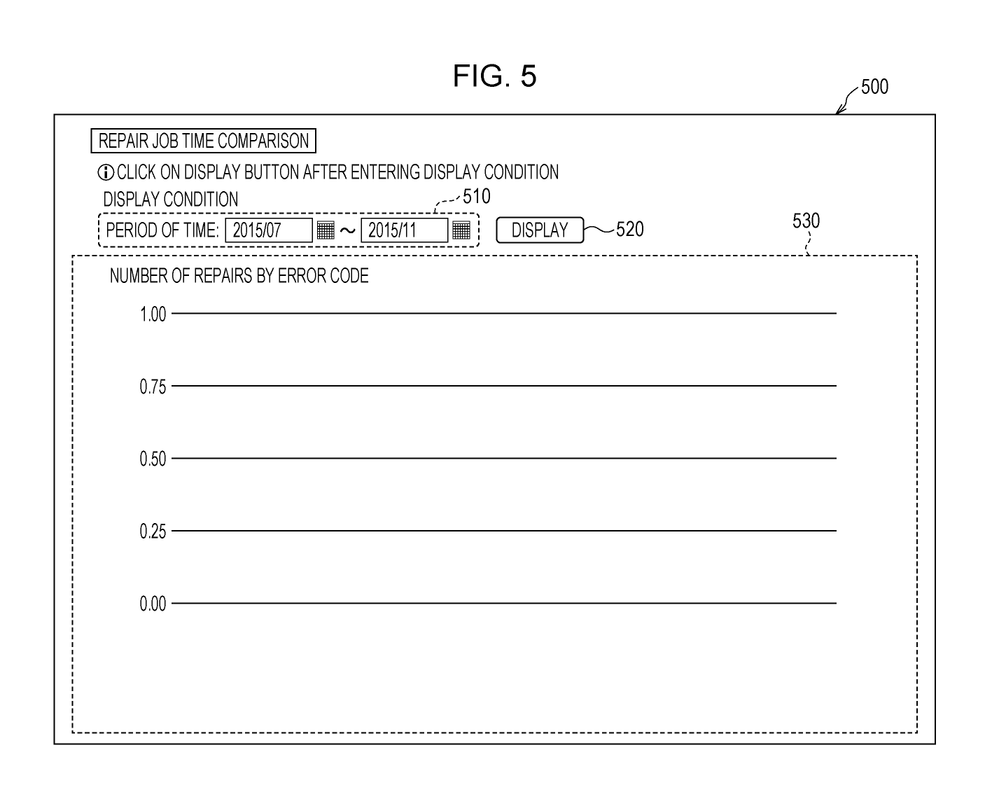

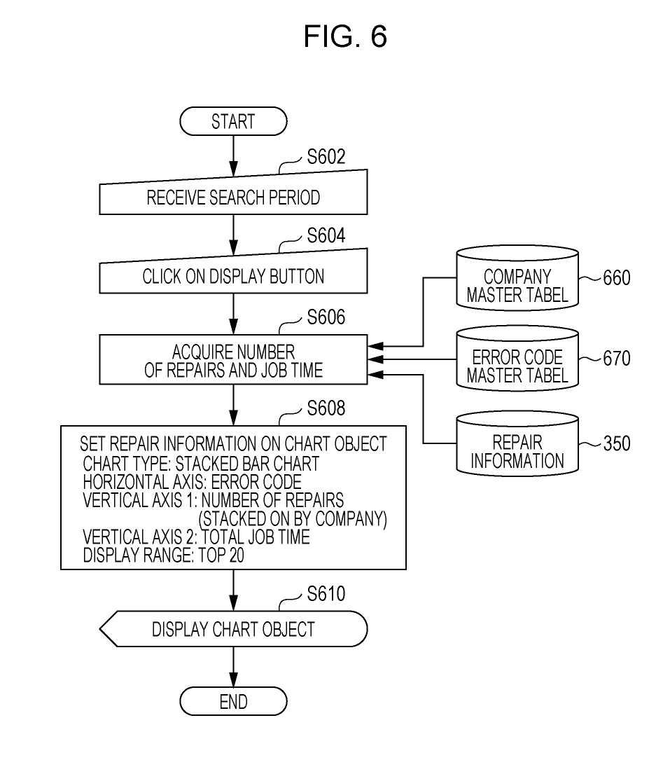

In step S304, an initial screen is displayed. For example, a screen 500 of FIG. 5 is displayed on the display 270. FIG. 5 illustrates a display example of the screen 500 in accordance with the exemplary embodiment. The screen 500 includes a period designate receiving region 510, a display button 520, and a graph display region 530. The period designate receiving region 510 is used to designate the extraction period 262. When the display button 520 is selected after the extraction period 262 is designated in the period designate receiving region 510, a process represented by a flowchart of FIG. 6 is performed, and the first phase graph is displayed in the graph display region 530.

FIG. 6 is the flowchart illustrating an example of a process of the exemplary embodiment (the first phase graph).

In step S602, the search period as the extraction period 262 is received.

In step S604, the clicking of the display button 520 is detected.

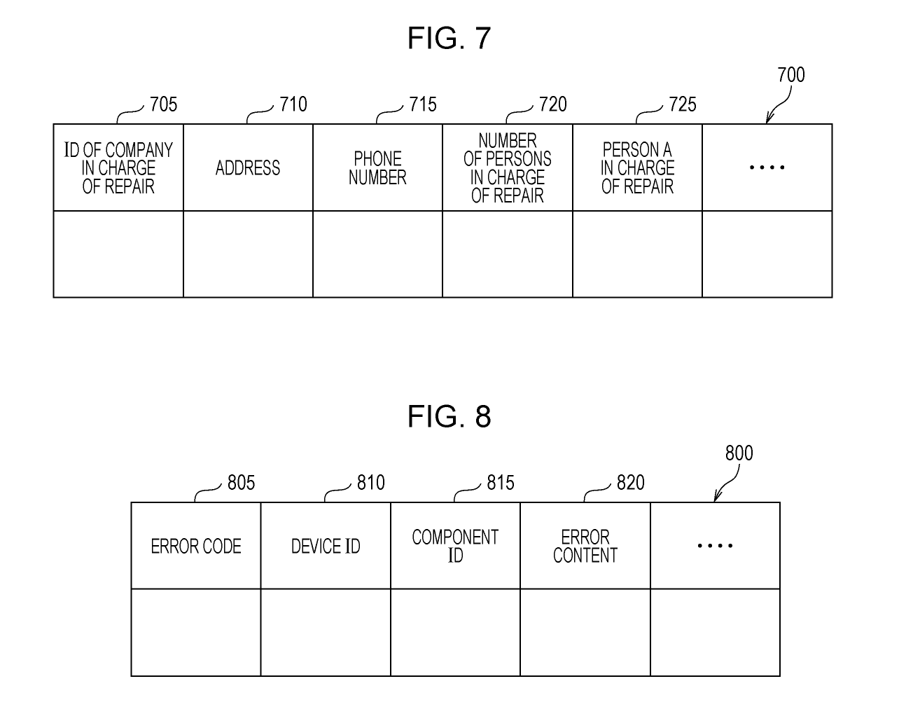

In step S606, the number of repairs and job time are acquired from the company master table 660, the error code master table 670, and the repair information 350. For example, a company master table 700 of FIG. 7 is available as the company master table 660. An error code master table 800 of FIG. 8 is available as the error code master table 670.

FIG. 7 illustrates a data structure of the company master table 700. The company master table 700 includes a company in charge of repair ID column 705, an address column 710, a phone number column 715, a number of persons in charge of repair column 720, and a person A in charge of repair column 725. In accordance with the exemplary embodiment, the company in charge of repair ID column 705 stores information uniquely identifying a company in charge of repair (a company in charge of repair ID). The address column 710 stores the address of the company in charge of repair. The phone number column 715 stores a telephone number of the company in charge of repair. The number of persons in charge of repair column 720 stores the number of persons in charge of repair. The person A in charge of repair column 725 stores a person A in charge of repair. The number of persons in charge of repair column 720 is followed by the person A in charge of repair columns 725 whose number equals to the value stored in the number of persons in charge of repair column 720.

FIG. 8 illustrates a data structure of the error code master table 800. The error code master table 800 includes an error code column 805, a device ID column 810, a component ID column 815, and an error content column 820. The error code column 805 stores an error code. The device ID column 810 stores a device ID. The component ID column 815 stores information uniquely identifying a component (component ID) in accordance with the exemplary embodiment. The error content column 820 stores error content.

In step S608, repair information is set up in a chart object. The chart object refers to an object (data group) that is used to display a graph. The chart object in the form of a graph designates a chart type: a stacked bar chart, a horizontal axis: error code, a vertical axis 1: the number of repairs (stacked on by company), a vertical axis 2: total job time, and a display range: top 20. Display content of the graph is thus created.

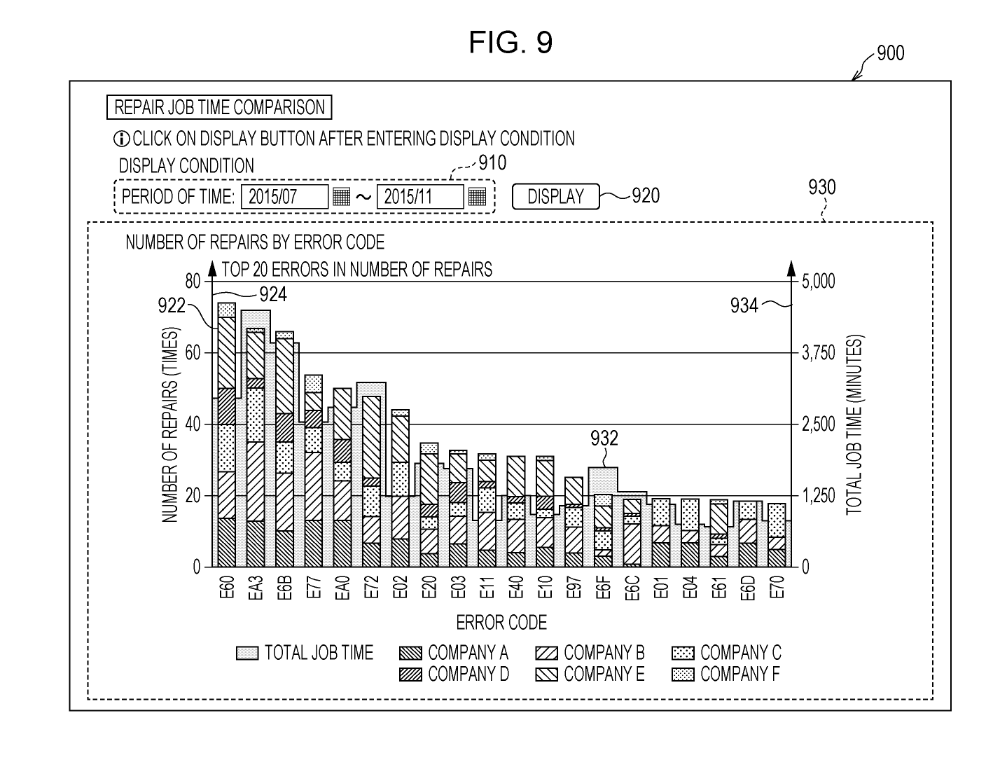

In step S610, the chart object is displayed. A screen 900 of FIG. 9 is displayed. FIG. 9 illustrates a display example of the screen 900 of the exemplary embodiment. The screen 900 includes a period designate receiving region 910, a display button 920, and a graph display region 930. A graph in the graph display region 930 is an example of the first phase graph. In the first phase graph, the number of jobs (the number of repair jobs herein) and the total job time (total job time) are displayed with respect to an item that is assumed to represent an identical job (an error code herein).

In response to a designate from the chart object, the graph display region 930 indicates error codes with respect to the horizontal axis, the number of repairs (stacked by company) with respect to a left vertical axis 924, and the total job times with respect to a right vertical axis 934. Bar graphs 922 are displayed with respect to the left vertical axis 924, and an area graph 932 is displayed with respect to the right vertical axis 934.

A bar graph (the bar graph 922, for example) in the graph display region 930 includes stacked bar sections differently colored for a company A, a company B, a company C, a company D, a company E, and a company F, and the height of each bar indicates the number of repairs with respect to the left vertical axis 924.

The area graph 932 in the graph display region 930 represents the total job time of each error code (with respect to the right vertical axis 934).

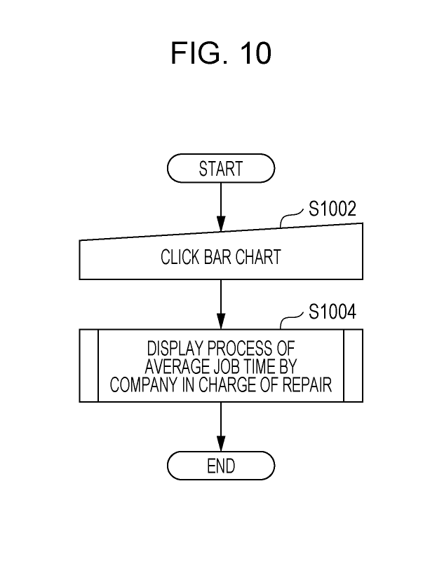

FIG. 10 is a flowchart illustrating an example of a process of the exemplary embodiment (the second phase graph).

In step S1002, the bar graph is clicked on. For example, the bar graph 922 in the graph display region 930 of FIG. 9 is clicked on.

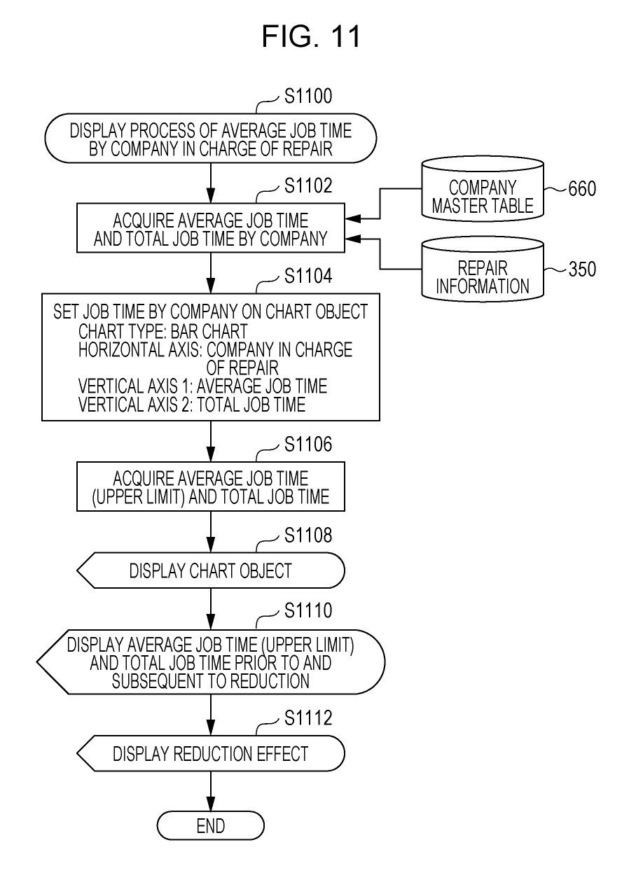

In step S1004, a display process of the average job time by company in charge of repair is performed. The detailed process of step S1004 is described with reference to a flowchart of FIG. 11.

FIG. 11 is a flowchart illustrating an example of a process of the exemplary embodiment.

In step S1100, a display process of the average job time by company in charge or repair is started.

In step S1102, the average job time and the total job time by company are acquired from the company master table 660 and the repair information 350.

In step S1104, the job time by company is set up in the chart object. For example, the chart object designates the chart type: bar graph, the horizontal axis: company in charge of repair, the vertical axis 1: average job time, and the vertical axis 2: total job time, and thus creates display content of graphs.

In step S1106, the average job time (upper limit) and the total job time are acquired.

In step S1108, the chart object is displayed.

In step S1110, the average job times (upper limit) prior to and subsequent to reduction, and the total job time are acquired.

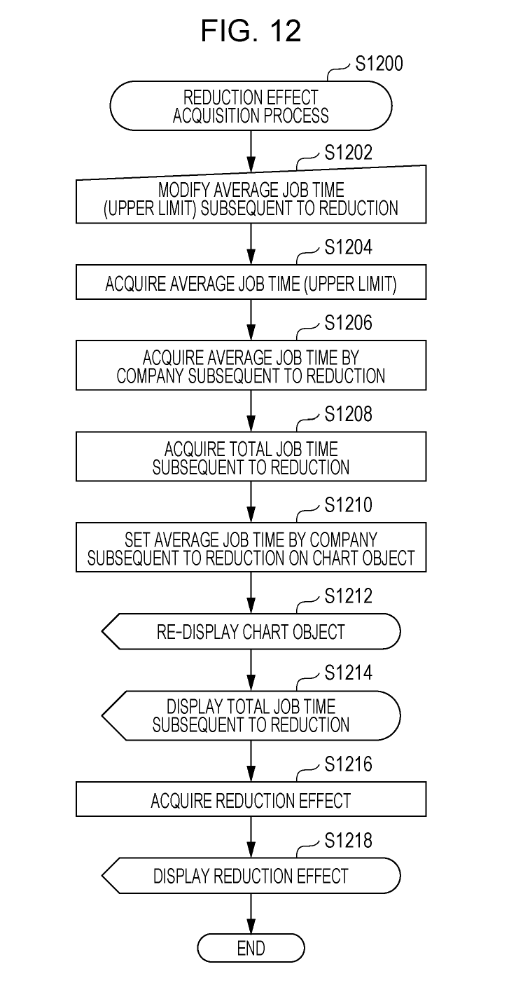

In step S1112, a reduction effect is displayed. The creation process of the reduction effect is described with reference to a flowchart of FIG. 12.

FIG. 12 is a flowchart illustrating an example of the process of the exemplary embodiment.

In step S1200, an acquisition process of the reduction effect is started.

In step S1202, the average job time (upper limit) subsequent to the reduction is modified.

In step S1204, the average job time (upper limit) subsequent to the reduction is acquired.

In step S1206, the average job time by company subsequent to the reduction is acquired.

In step S1208, the total job time subsequent to the reduction is acquired.

In step S1210, the average job time by company subsequent to the reduction is set in the chart object.

In step S1212, the chart object is re-displayed.

In step S1214, the total job time subsequent to the reduction is displayed.

In step S1216, the reduction effect is acquired.

In step S1218, the reduction effect is displayed.

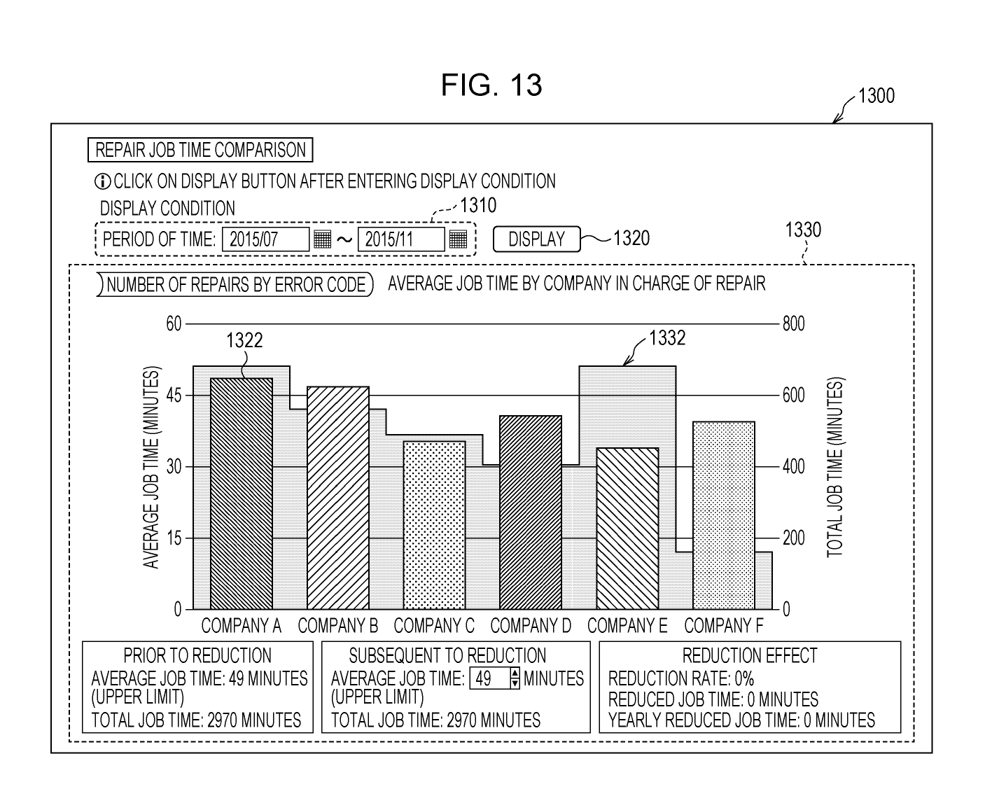

FIG. 13 illustrates a display example of a screen 1300 of the exemplary embodiment. The screen 1300 is a graph example displayed in step S1108 in the flowchart of FIG. 11. The screen 1300 includes a period designate receiving region 1310, a display button 1320, and a graph display region 1330. A graph in the graph display region 1330 is a graph example (1) of the second phase graph. In the graph display region 1330, a statistical value of the job time of the item (the average job time herein) and the sum of job time (the total job time) are displayed on a single graph according to an organization or a person having performed the job (a company herein).

In response to a designate of the chart object, the graph display region 1330 indicates companies in charge of repair along the horizontal axis, the average job time with respect to the left vertical axis, and the total job time with respect to the right vertical axis. A bar graph, such as a bar graph 1322, is displayed with respect to the left vertical axis, and an area graph 1332 is displayed with respect to the right vertical axis.

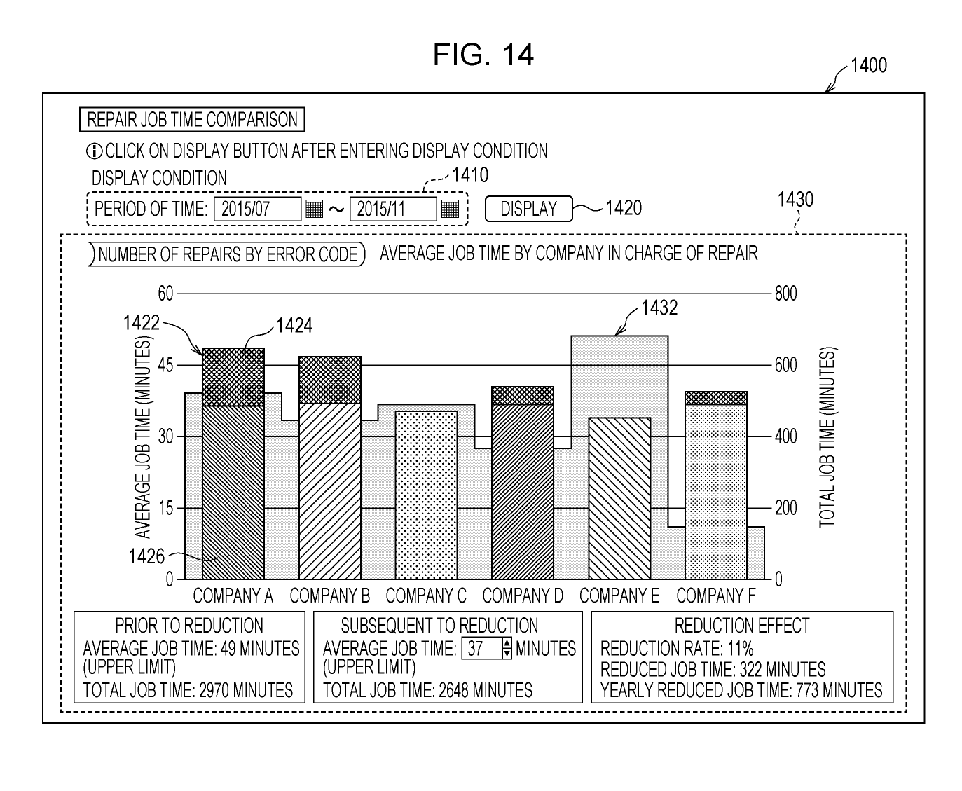

FIG. 14 illustrates a display example of a screen 1400 of the exemplary embodiment. The screen 1400 is a graph example displayed in step S1212 in the flowchart of FIG. 12. The screen 1400 includes a period designate receiving region 1410, a display button 1420, and a graph display region 1430. A graph in the graph display region 1430 is a graph example (2) of the second phase graph. In the graph display region 1430, a graph (a bar graph 1422 herein) is divided into a job time portion having a statistical value as a target (a designate job time portion 1426 herein) and a reduction portion (a reduction portion 1424 herein), and then displayed. A graph of sum (an area graph 1432 herein) is displayed with the graph of sum set to be a target of job time.

In response to a designate from the chart object, the graph display region 1430 indicates companies in charge of repair along the horizontal axis, the average job time with respect to the left vertical axis, and the total job time with respect to the right vertical axis. Each bar graph, such as the bar graph 1422, is displayed with respect to the left vertical axis. The area graph 1432 is displayed with respect to the right vertical axis. The bar graph 1422 is divided into the designate job time portion 1426 and the reduction portion 1424. Other bar graphs are also similarly divided. However, a bar graph having the average job time falling with a job time target (the bar graphs of the companies C and E) is free from division.

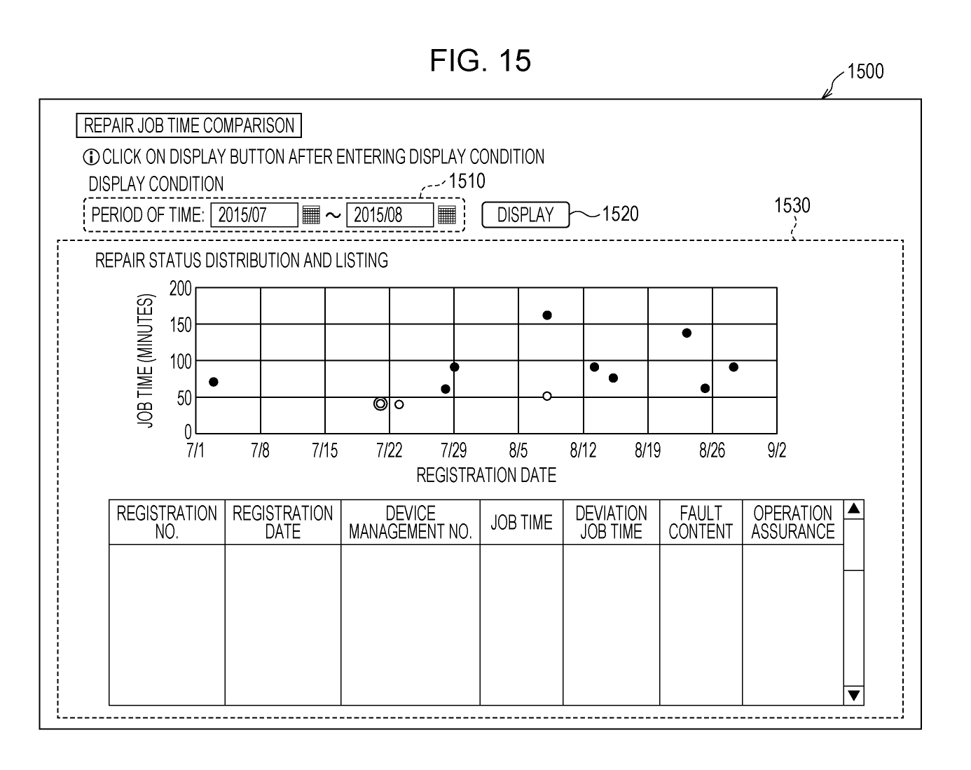

FIG. 15 illustrates a display example of a screen 1500 of the exemplary embodiment. The screen 1500 includes a period designate receiving region 1510, a display button 1520, and a graph display region 1530. A graph in the screen 1500 is an example of the third phase graph. If an item in the second phase graph is selected by an operator, the job time of the selected item (the bar graph 1422 of FIG. 14, for example) is displayed by time and date on which the job has been performed (in a graph plotted with blank circles and solid circles).

The graph in the graph display region 1530 indicates time and date along the horizontal axis, and the job time with respect to the vertical axis. Each of the solid circles and blank circles is drawn at a location that is determined by a combination of the time and date and the job time at each job in the selected item. Each solid circle represents a job that is not within target job time, and each blank circle represents a job that is within the target job time.

A table displayed below the graph display region 1530 may include contents of each job (repair). For example, the table may lists a registration number, a registration date, a device management number, job time, deviation job time, fault content, and operation assurance.

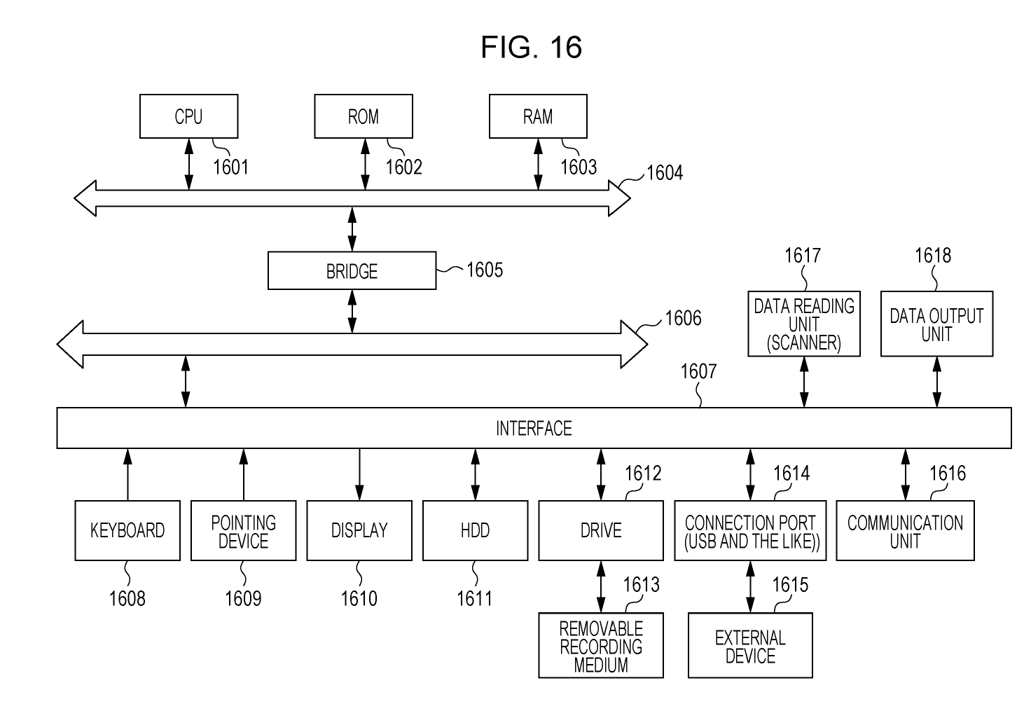

A hardware configuration of the information processing apparatus of the exemplary embodiment is described with reference to FIG. 16. The hardware configuration of FIG. 16 may be implemented by a personal computer (PC), for example, and includes a data reading unit 1617, such as a scanner, and a data output unit 1618, such as a printer.

A central processing unit (CPU) 1601 is a controller that performs processes in accordance with a computer program that describes an execution sequence of each of the modules described above. The modules include the communication module 105, the data storage module 110, the data extracting module 115, the data collecting module 120, the data calculating module 125, the comparing and recommending module 130, the display module 135, and the designating module 260.

A read-only memory (ROM) 1602 stores a program and an arithmetic parameter used by the CPU 1601. A random-access memory (RAM) 1603 stores a program executed by the CPU 1601, or a parameter that changes as appropriate in the execution of the program. These elements are interconnected via a host bus 1604 including a CPU bus.

The host bus 1604 is connected to an external bus 1606, such as a peripheral component interconnect/interface (PCI) bus and the like, via a bridge 1605.

A keyboard 1608 and a pointing device 1609, such as a mouse, are devices that are operated by the user. A display 1610 may be a liquid-crystal display device or a cathode ray tube (CRT), and displays a variety of information as text or image information. Alternatively, a touch screen having the functionalities of both the pointing device 1609 and the display 1610 may be used. In such a case, the functionality of the keyboard is implemented by displaying a keyboard on a screen (touch screen) through software (this on-screen key board is referred to as a software keyboard or a screen keyboard) without physically connecting the keyboard 1608. The functionality of the keyboard is thus implemented.

A hard disk drive (HDD) 1611 including a hard disk (or a flash memory) drives a hard disk, and records or reproduces information and the program executed by the CPU 1601. The hard disk stores the repair information 350, the company master table 660, the error code master table 670, and the like. The hard disk also stores another variety of data and a variety of computer programs.

A drive 1612 reads data or a program recorded on a loaded removable recording medium 1613, such as a magnetic disk, an optical disk, a magneto-optical disk, or a semiconductor memory, and then sends the data or program to the connected RAM 1603 via an interface 1607, external bus 1606, bridge 1605, and host bus 1604. The removable recording medium 1613 may also be used as a data recording region.

A connection port 1614 connects an external device 1615 to the PC, and includes a connection unit of a universal serial bus (USB), or IEEE 1394. The connection port 1614 is connected to the CPU 1601 and the like via the interface 1607, the external bus 1606, the bridge 1605, and the host bus 1604. A communication unit 1616 is connected to the communication network, and performs data communication with the outside. The data reading unit 1617 is a scanner, for example, and reads a document. The data output unit 1618 is a printer, for example, and performs an output operation on document data.

The hardware configuration of FIG. 16 of the processing apparatus indicates a configuration example only. The exemplary embodiment is not limited to this hardware configuration of FIG. 16 and may be acceptable in any form as long as the modules of the exemplary embodiment are implemented. For example, some modules may be implemented using dedicated hardware, such as an application specific integrated circuit (ASIC). In another example, some modules may be in an external system and connected to the system of FIG. 16 via a communication network. In yet another example, plural systems of FIG. 16 may be interconnected to each other via a communication network such that the systems operate in concert with each other. One of the modules may be incorporated not only in a personal computer, but also in a portable information communication apparatus (such as a cellular phone, a smart phone, a mobile device, or a wearable computer), an information home appliance, a robot, a copying machine, a facsimile device, a scanner, a printer, a multi-function apparatus or a multi-function apparatus (an image processing apparatus having at least two of functionalities of the scanner, the printer, the copying machine, and the facsimile device).

In accordance with the exemplary embodiment, categorization is performed according to an error code (failure factor), but may be performed according to an inspection item.

The above-described program may be supplied in a stored state on a recording medium. The program may also be provided via communications. In such a case, the above-described program may be understood as an invention of a “non-transitory computer readable recording medium storing the program”.

The “non-transitory computer readable recording medium storing the program” refers to a computer readable recording medium storing the program, and is used to install the program, to execute the program, or to distribute the program.

The recording media include digital versatile disk (DVD), compact disk (CD), Blu-ray disk (registered trademark), magneto-optical disk (MO), flexible disk (FD), magnetic tape, hard disk, read-only memory (ROM), electronically erasable and programmable read-only memory (EEPROM (registered trademark)), flash memory, random-access memory (RAM), and secure digital (SD) memory card. The DVDs include “DVD-R, DVD-RW, and DVD-RAM”, each complying with the standard formulated by the DVD forum, and “DVD+R and DVD+RW” complying with DVD+RW standards. The CDs include read-only CD (CD-ROM), recordable CD-R, and rewritable CD-RW.

The program in whole or in part may be stored on the recording medium for storage and distribution. The program in whole or in part may be transmitted via a transfer medium. The transfer media include a wired network, a wireless network, or a combination thereof. The wired and wireless networks may include a local-area network (LAN), a metropolitan-area network (MAN), a wide-area network (WAN), the Internet, an intranet, and an extranet. The program in whole or in part may be transmitted over a carrier wave.

The program may be part or whole of another program, or may be stored on the recording medium together with another program. The program may be split and split programs may then be separately stored on the recording media. The program may be processed in any fashion before being stored as long as the program remains restorable. For example, the program may be compressed or encrypted before storage.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an extracting unit that extracts a number of jobs and job time on a device; and
a display that displays on a single graph the number of jobs and total job time in accordance with item, with each item determined to indicate an identical job.

2. The information processing apparatus according to claim 1, further comprising a second display that, if an item displayed on the display is selected by an operator, displays on the single graph a statistical value of the job time of the item and the total job time in accordance with organization or person, each organization or person having performed a job.

3. The information processing apparatus according to claim 2, wherein the second display divides the graph into a job time portion having the statistical value as a target and a reduction portion, and displays the divided graph together with a graph representing the total job time that is set to be a target.

4. The information processing apparatus according to claim 2, further comprising a third display that, if an item displayed on the second display is selected by the operator, displays job time of the item in accordance with time and date on which the job has been performed.

5. The information processing apparatus according to claim 3, further comprising a third display that, if an item displayed on the second display is selected by the operator, displays job time of the item in accordance with time and date on which the job has been performed.

6. The information processing apparatus according to claim 1, wherein the third display displays a job, which is not within the job time as the target, in a form which is different from a form of the job within the job time.

7. The information processing apparatus according to claim 1, further comprising a fourth display that calculates total times of reduction time in accordance with a failure factor with the job time set as the target, and displays the total times in a descending order of from a higher value to a lower value.

8. The information processing apparatus according to claim 2, wherein the item is a failure factor or an inspection item.

9. A non-transitory computer readable medium storing a program causing a computer to execute a process for processing information, the process comprising:
extracting a number of jobs and job time on a device; and
displaying on a single graph the number of jobs and total job time in accordance with item, with each item determined to indicate an identical job.
